(19) United States
(12) Patent Application Publication
(10) Pub. No.: US 2025/0286433 A1
(43) Pub. Date: Sep. 11, 2025

(54) IN-WHEEL MOTOR SYSTEM

(71) Applicants: HYUNDAI MOTOR COMPANY, Seoul (KR); KIA CORPORATION, Seoul (KR)

(72) Inventors: Dang Hee Park, Seoul (KR); Kwon Su Shin, Incheon (KR); Jeong Uk An, Suwon-si (KR); Ki Tack Lim, Incheon (KR); Yong Sok Jang, Suwon-si (KR); Kyung Ku Yeo, Yongin-si (KR); Chee Mann Kim, Seoul (KR); Kyung Jun Lee, Seoul (KR); Kam Chun Lee, Seoul (KR); Sung Ho Lee, Seongnam-si (KR); Jae Joon Lee, Seoul (KR); Hoan Ju Yoo, Ansan-si (KR); Dong Su Lee, Seoul (KR); Hong Wook Lee, Seongnam-si (KR); Jae Young Jeun, Yongin-si (KR)

(73) Assignees: HYUNDAI MOTOR COMPANY, Seoul (KR); KIA CORPORATION, Seoul (KR)

(21) Appl. No.: 18/920,522

(22) Filed: Oct. 18, 2024

(30) Foreign Application Priority Data
Mar. 5, 2024 (KR) 10-2024-0031163

(51) Int. Cl. H02K 7/102; B60K 7/00; B60T 1/02; H02K 1/20; H02K 3/34; H02K 21/22

(52) U.S. Cl. CPC H02K 7/102; B60K 7/0007; H02K 1/20; H02K 3/345; H02K 21/22; B60K 2007/0092; B60T 1/02

(57) ABSTRACT

An in-wheel motor system includes a fixed part, a rotating part configured to be rotatable relative to the fixed part, and a brake mounted on the fixed part. The brake includes a friction material disposed to contact the rotating part.

### CROSS-REFERENCE TO RELATED APPLICATION

This application claims, under 35 U.S.C. § 119(a), the benefit of priority to Korean Patent Application No. 10-2024-0031163, filed Mar. 5, 2024, the entire contents of which are incorporated herein by reference.

### TECHNICAL FIELD

The present disclosure relates to an in-wheel motor system.

### BACKGROUND

Electric vehicles driven by motors instead of engines have received considerable attention in recent years. Generally, electric vehicles are configured to be driven by one or two large motors. In-wheel motors widely used in small vehicles such as electric bicycles and scooters are being applied to electric cars.

An in-wheel motor is an electric motor mounted in a wheel of a vehicle and configured to directly rotate the wheel. Specifically, in an electric vehicle driven by the in-wheel motor, a small motor is mounted in each wheel to independently drive and control each wheel.

The electric vehicle having the in-wheel motor mounted therein may provide various advantages such as excellent space utilization and improved control performance compared to an electric vehicle having an existing large motor mounted therein. However, since the electric vehicle driven by the in-wheel motor has a motor provided in each wheel, it is necessary to meet several design conditions different from design conditions of an electric vehicle driven by one large motor.

The above information disclosed in this Background section is only for enhancement of understanding of the background of the disclosure, and therefore it may contain information that does not form the prior art that is already known to a person of ordinary skill in the art.

### SUMMARY

The present disclosure has been made in an effort to solve the above-described problems associated with the prior art. It is an object of the present disclosure to provide an in-wheel motor system configured to reduce a size of an in-wheel motor and also to enable high output.

It is another object of the present disclosure to provide an in-wheel motor system having improved efficiency.

The objects of the present disclosure are not limited to the above-mentioned objects. Other technical objects not mentioned herein should be more clearly understood by one having ordinary skill in the art to which the present disclosure pertains from the detailed description of the embodiments.

In one aspect, the present disclosure provides an in-wheel motor system including a fixed part, a rotating part configured to be rotatable relative to the fixed part, and a brake mounted on the fixed part. The brake includes a friction material disposed to contact the rotating part.

Other aspects and embodiments of the present disclosure are discussed below.

It should be understood that the terms “vehicle”, “vehicular”, and other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are described in detail with reference to embodiments thereof illustrated in the accompanying drawings which are given hereinbelow by way of illustration only, and thus are not limitative of the present disclosure.

FIG. 1 is a cross-sectional view of an in-wheel motor system according to an embodiment of the present disclosure.

FIG. 2 is a cross-sectional view of a portion of the in-wheel motor system according to an embodiment of the present disclosure.

FIG. 3 is a perspective view of a main body of a modular coil for the in-wheel motor system according to an embodiment of the present disclosure.

FIG. 4 is a perspective view of the modular coil for the in-wheel motor system according to an embodiment of the present disclosure.

FIG. 5 is a view showing a stator of the in-wheel motor system including the modular coil according to an embodiment of the present disclosure.

FIG. 6 is a view showing a protective body for the modular coil according to an embodiment of the present disclosure.

FIG. 7 is an unfolded view of FIG. 6.

FIG. 8 is an exploded perspective view of the modular coil and the protective body according to an embodiment of the present disclosure.

FIG. 9 is a view showing a process of mounting the modular coil and the protection body according to an embodiment of the present disclosure on the stator of the in-wheel motor system.

FIG. 10 is a view showing some components of the in-wheel motor system including the modular coil according to an embodiment of the present disclosure.

FIG. 11 is a cross-sectional view when the components in FIG. 10 are combined.

FIG. 12 is an enlarged view of a portion S1 in FIG. 11.

FIG. 13 is an enlarged view of a portion S2 in FIG. 11.

FIG. 14 is a view showing a cooling housing of the in-wheel motor system according to an embodiment of the present disclosure.

FIG. 15 is a view showing a cooling channel formed in the cooling housing of the in-wheel motor system according to an embodiment of the present disclosure.

### DETAILED DESCRIPTION

Specific structural or functional descriptions given in connection with the embodiments of the present disclosure are merely illustrative for the purpose of describing embodiments according to the concept of the present disclosure. The embodiments according to the concept of the present disclosure may be implemented in various forms. Further, it should be understood that the present description is not intended to limit the disclosure to the embodiments. On the contrary, the disclosure is intended to cover not only the embodiments, but also various alternatives, modifications, equivalents, and other embodiments, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, i.e., “between” and “directly between” or “adjacent to” and “directly adjacent to,” should be interpreted in the same manner.

The same reference numerals represent the same components throughout the specification. Additionally, the terms in the specification are used merely to describe embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described. The same understanding should apply to terms such as “have”, “include”, and the like, and variations thereof.

Hereinafter, the present disclosure is described in detail with reference to the accompanying drawings. When a component, device, element, or the like of the present disclosure is described as having a purpose or performing an operation, function, or the like, the component, device, or element should be considered herein as being “configured to” meet that purpose or perform that operation or function.

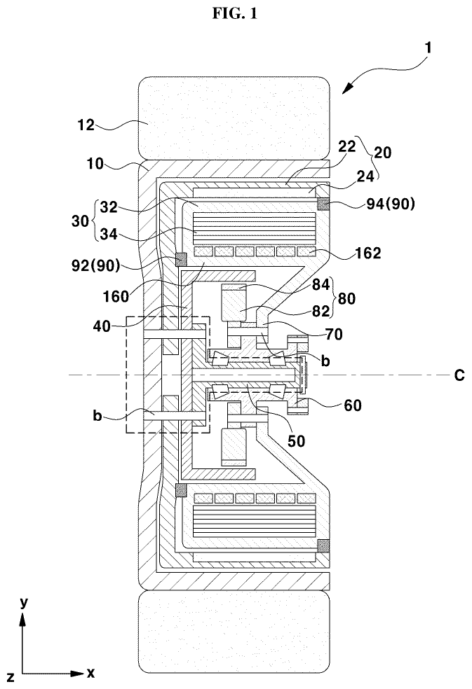

As shown in FIG. 1, an in-wheel motor system 1 according to an embodiment of the present disclosure may be mounted in a wheel 10 of a vehicle. The x-axis direction refers to the lateral direction of the vehicle, the y-axis direction refers to the vertical direction, and the z-axis direction refers to the longitudinal direction of the vehicle. Accordingly, the in-wheel motor system 1 in FIG. 1 is installed on the wheel on the driver's seat side of the vehicle. In other words, the left side of FIG. 1 is the outer side of the vehicle, and the right side is the inner side of the vehicle.

The in-wheel motor system 1 is configured to be rotatable within the wheel 10 to directly rotate the wheel 10. To this end, the in-wheel motor 1 includes a rotating part and a fixed part.

The rotating part is configured to be rotatable relative to the fixed part. The rotating part is configured to be rotatable, particularly, by electromagnetic interaction between a rotor 20 serving as the rotating part and a stator 30 serving as the fixed part. In one embodiment, the in-wheel motor system 1 may be an outer rotor type motor in which the rotor 20 is disposed radially outward relative to the stator 30.

The rotor 20 includes a rotor core 22 and a first magnetic member 24. One or more first magnetic members 24 may be mounted on the rotor core 22. The stator 30 includes a stator core 32 and a second magnetic member 34. One or more second magnetic members 34 may be mounted on the stator core 32.

In some embodiments, both the first magnetic member 24 and the second magnetic member 34 may be electromagnets configured to allow current to be applied thereto. In some embodiments, any one of the first magnetic member 24 and the second magnetic member 34 may be a permanent magnet, and the other one may be an electromagnet. For example, the first magnetic member 24 may be a permanent magnet, and the second magnetic member 34 may be an electromagnet. In this specification, a description is given as to an example in which the first magnetic member 24 of the rotor 20 is a permanent magnet, and the second magnetic member 34 of the stator 30 is an electromagnet.

The first magnetic member 24 and the second magnetic member 34 may interact electromagnetically by magnetization of the second magnetic member 34 of the stator 30. When a current supplied to the second magnetic member 34 is adjusted, the rotor 20 including the first magnetic member 24 may be rotatable around a centerline C of the wheel 10 relative to the stator 30 including the second magnetic member 34.

The rotating part may further include an inner cover 40 and a shaft 50. The shaft 50 may be coupled to the center of the rotor 20, and the shaft 50 may be coupled to the inner cover 40. The inner cover 40 may prevent foreign substances from flowing into the in-wheel motor system 1 and may protect components, such as a brake 80 and a wheel bearing 60. Which are positioned radially inside the stator 30. Additionally, the wheel 10 having a tire 12 mounted thereon may be coupled to the shaft 50. For example, the rotor 20, the inner cover 40, the shaft 50, and the wheel 10 may be coupled to each other by a coupling member (b), which may be detachably coupled to each other. In some embodiments, the rotor 20, the inner cover 40, and the shaft 50 may be integrally formed with each other without the coupling member (b).

The rotating part is rotatably coupled to the fixed part. Specifically, the shaft 50 of the rotating part is rotatably disposed relative to the fixed part by the wheel bearing 60. In addition to the stator 30, the fixed part may include a support bracket 70, the wheel bearing 60, the brake 80, and a cooling housing 160.

The stator 30 may be fixedly connected to a vehicle by the support bracket 70. For example, the support bracket 70 may be detachably coupled to the stator core 32 through a coupling member (not shown). Also, the wheel bearing 60 and the brake 80 may be detachably coupled to the support bracket 70. For example, the coupling member (b) may detachably couple the support bracket 70, the wheel bearing 60, and the brake 80 to each other.

The in-wheel motor system 1 further includes an annular seal 90. The seal 90 may include an outer seal 92 and an inner seal 94. A space between the rotor 20 and the stator 30 is sealed by the seal 90 on opposite sides in the x-axis direction or the axial direction of the rotor 20 and the stator 30. In one embodiment, the seal 90 includes the outer seal 92 disposed on the outer side of a vehicle in the lateral direction x and the inner seal 94 located closer to the center of the vehicle than the outer seal 92. As a non-limiting example, the seal 90 may be made of rubber.

According to an embodiment of the present disclosure, the in-wheel motor system 1 includes the brake 80. The brake 80 may be coupled to the radially outer side of the wheel bearing 60. According to an embodiment of the present disclosure, the brake 80 may include a cylinder 82 and a friction material 84. The cylinder 82 may be a hydraulic cylinder.

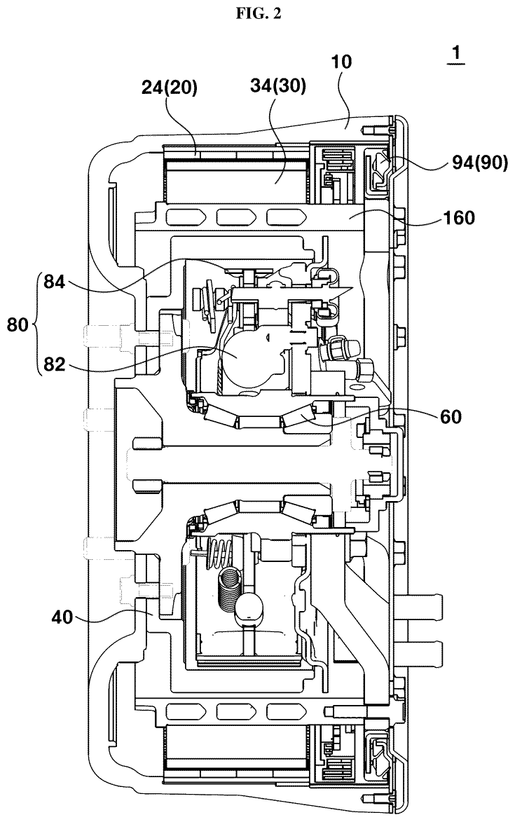

Referring to FIG. 2, the brake 80 may operate in conjunction with the inner cover 40. The friction material 84 of the brake 80 may use an inner surface 42 of the inner cover 40 as a friction surface. Through this configuration, the brake 80 may be provided in the in-wheel motor system 1 without an additional increase in size.

When the cylinder 82 is operated in response to an operation request of the brake 80, the friction material 84 contacts the inner surface of the inner cover 40, thereby generating braking force. Also, the brake 80 may further include a return spring (not shown). The return spring may provide force to return the friction material 84 to the original position thereof when the operation of the brake 80 is terminated. The in-wheel motor system 1 according to an embodiment of the present disclosure utilizes the inner cover 40 and unused space in an in-wheel motor, thereby making it possible not only to prevent an increase in the size of the in-wheel motor system 1, but also to secure effects, such as sound insulation and rust prevention, through the inner cover 40. Through the above-described structure, the in-wheel motor system 1 according to an embodiment of the present disclosure may be compactly designed, and an in-wheel motor may be applied to wheels of 16 inches or less. In the related art, in order to implement an in-wheel motor configured to generate high output, it is required to apply an in-wheel motor only to wheels of 19 inches or larger due to an inevitable increase in size.

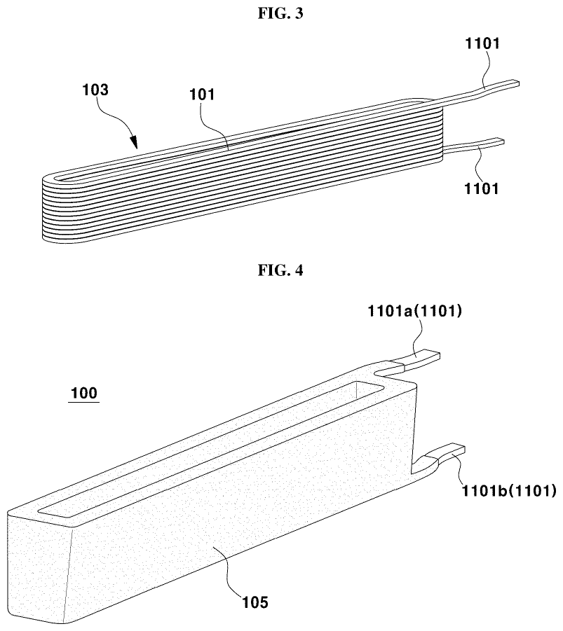

Referring to FIG. 3, the in-wheel motor system 1 may include a modular coil 100. The modular coil 100 may be applied as the second magnetic member 34.

In the modular coil 100, a coil 101 is wound to form a main body 103 based on a preset shape. As used herein, the main body 103 may mean the coil 101 formed in the preset shape. In addition, the coil 101 may be a flat plate coil. The flat plate coil 101 may increase magnetic flux density by minimizing an empty space and improving an occupying ratio of the coil. In some embodiments, the main body 103 may be formed by winding the coil 101. In some embodiments, the main body 103 may be formed by three-dimensionally printing a coil material.

In an embodiment shown in the drawing, an end 1101 of the coil 101 is configured to protrude outward from the main body 103 for an electrical connection with other components. A first end 1101a and a second end 1101b of the coil 101 may be formed on the same side of the main body 103 and may be extended in the same direction in a state of being spaced apart from each other.

As shown in FIG. 4, the main body 103 includes a coating layer 105. The coating layer 105 may mean a molding layer or a coating layer. The coating layer 105 is configured to insulate the main body 103 and protect the main body 103. In addition, the moldable coating layer 105 may surround the main body 103 in a shape that allows easy assemble of the modular coil 100. According to an embodiment of the present disclosure, the coating layer 105 may prevent an electrical short that may occur when the coils 101 are stacked and may improve durability of the coil 101.

After the coating layer 105 surrounds the main body 103, the first end 1101a and the second end 1101b are adapted to be connected to a bus bar 150 for electrical connection. A part of the first end 1101a and the second end 1101b each extending from the main body 103 may be configured not to be surrounded by the coating layer 105.

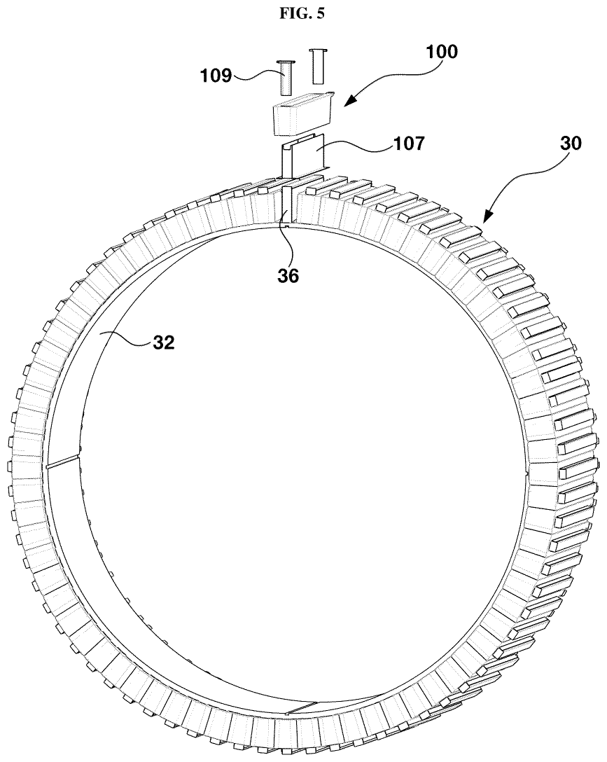

As shown in FIG. 5, the modular coil 100 may be mounted on the stator core 32 of the stator 30. The modular coil 100 may be mounted on a corresponding one of teeth 36 provided in the stator core 32. The teeth 36 may be formed to be spaced apart from each other by a predetermined gap along the circumference of the stator core 32. In some embodiments, when the in-wheel motor system 1 is an outer rotor type motor, the teeth 36 are configured to extend outward in the radial direction of the stator core 32 from the stator core 32.

The modular coil 100 may be mounted on a corresponding one of the teeth 36 through a protective body. The protective body may improve insulation performance of the modular coil 100. In some embodiments, the protective body may include a protective sheet 107. As a non-limiting example, the protective sheet 107 may be insulating paper. Each protective sheet 107 is molded in a shape capable of surrounding a corresponding one of the teeth 36.

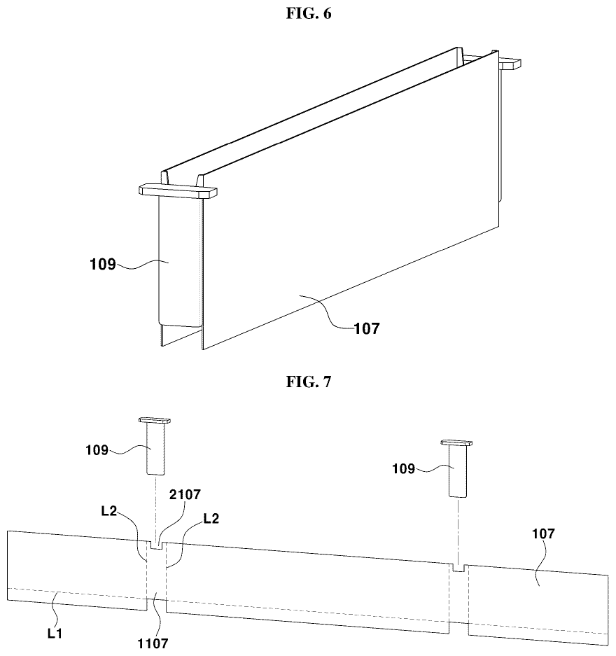

Referring to FIG. 6, in another embodiment, the protective body may include the protective sheet 107 and a support 109. Each protective sheet 107 is molded into a predetermined shape, capable of surrounding a corresponding one of the teeth 36, and the support 109 is attached to opposite sides of the protective sheets 107. For example, the support 109 may be coupled to the protective sheets 107 by an adhesive.

As shown in FIG. 7, folding lines L1 and L2 are arranged in the protective sheet 107. The folding lines L1 and L2 include the longitudinal folding line L1 extending in the longitudinal direction of the protective sheet 107 and the lateral folding line L2 extending perpendicular to the longitudinal folding line L1.

In an embodiment, a seating part 1107 is provided between the lateral folding lines L2 of the protective sheet 107. The support 109 is configured to be attached to the seating part 1107. In one embodiment, grooves 2107 may be respectively provided at opposite ends of the seating part 1107. Each of the grooves 2107 is provided to indicate the position of the support 109 so that an attachment position of the support 109 is easily determined.

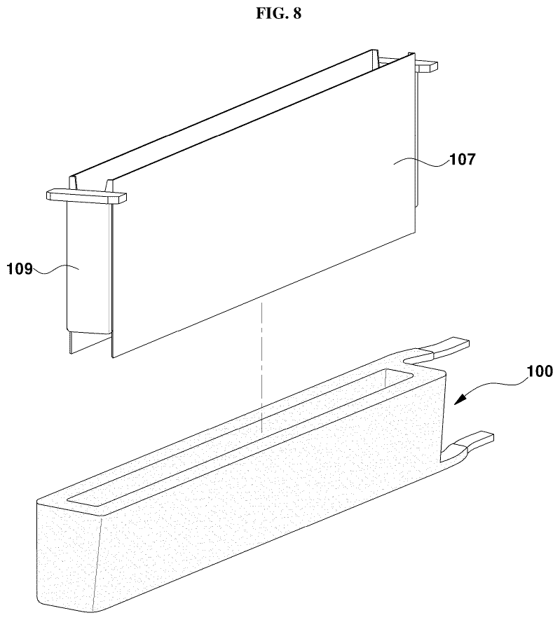

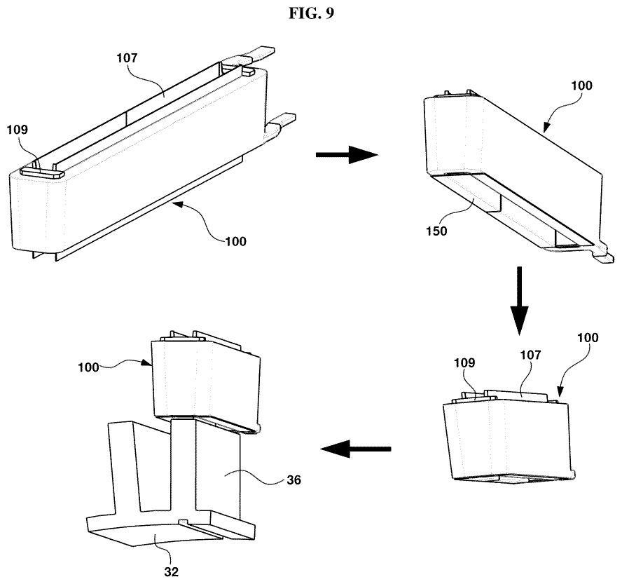

As shown in FIG. 8, after the support 109 is coupled to the protective sheet 107, the protective sheet 107 is formed along the lateral folding line L2. The protective sheet 107 folded in this manner may be inserted into the modular coil 100.

Referring to FIG. 9, the inserted protective sheet 107 is folded toward the modular coil 100 along the longitudinal folding line L1. Accordingly, the modular coil 100 may contact the stator core 32 through the protective sheet 107. When the protective sheet 107 is completely folded, the modular coil 100 may be inserted into a corresponding one of the teeth 36.

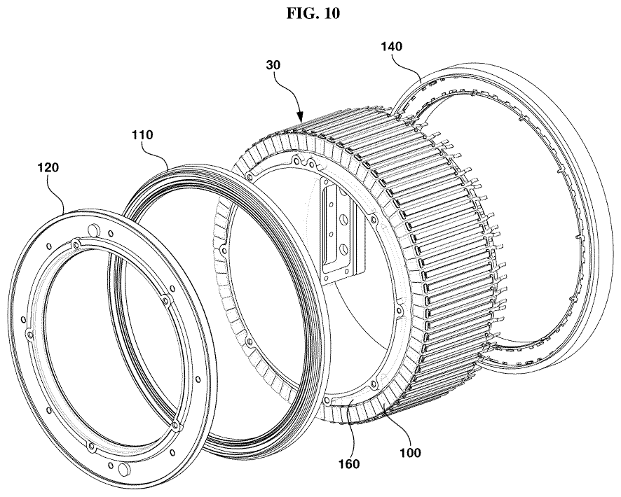

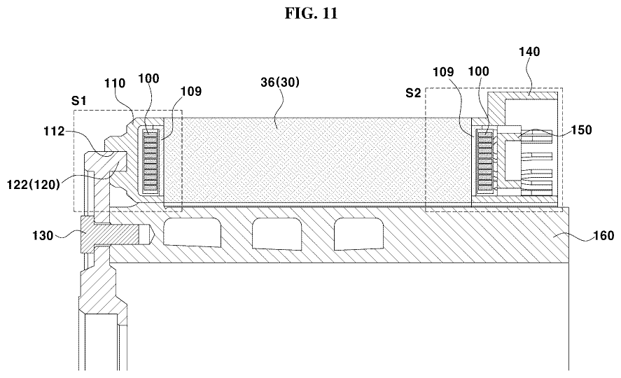

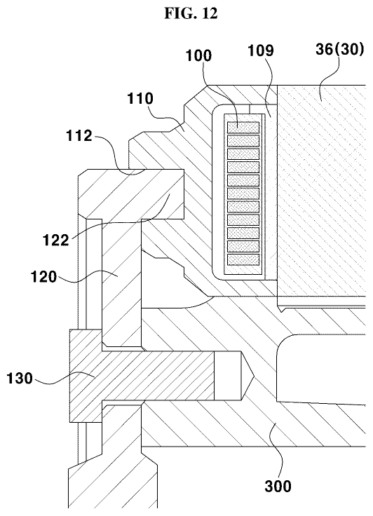

As shown in FIGS. 10 and 11, according to an embodiment of the present disclosure, the modular coil 100 mounted on the stator core 32 may be fixed and protected by the components of the in-wheel motor system 1. A front cover 110 is disposed at one side of the stator 30. The front cover 110 is disposed to cover a first side of the modular coil 100. The front cover 110 may be fixed by a seal housing 120 for the outer seal 92. The outer seal 92 is disposed in the seal housing 120 so as to prevent foreign substances from the outside from flowing into the motor. The seal housing 120 may be coupled to the cooling housing 160 disposed radially inside the stator core 32 through a bolt 130. Referring to FIG. 12, in some embodiments, the seal housing 120 may have a coupling part 122 provided therein and the front cover 110 may have an accommodation part 112 provided therein. When the coupling part 122 and the accommodation part 112 are engaged with each other, the front cover 110 may be fixed.

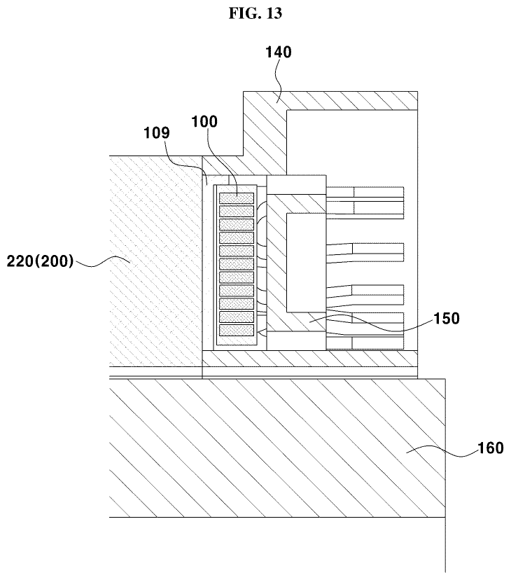

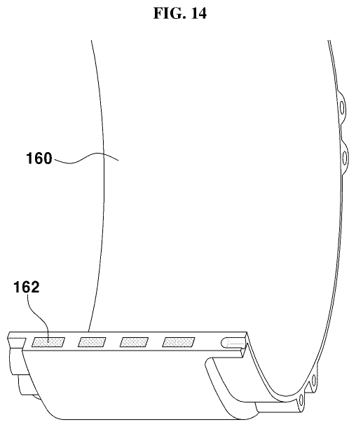

Referring to FIG. 13, a rear cover 140 is disposed at a second side of the stator 30. The second side of the stator 30 may be an opposite end of the first side. The rear cover 140 is disposed to cover the second side of the modular coil 100. A bus bar 150 for electrical connection is mounted on the second side of the modular coil 100. The rear cover 140 may accommodate the bus bar 150 and the modular coil 100 therein. In this manner, the bus bar 150 and the modular coil 100 are located in the rear cover 140. The rear cover 140 may be fixed by the cooling housing 160. In some embodiments, the rear cover 140 may be a cover for a busbar.

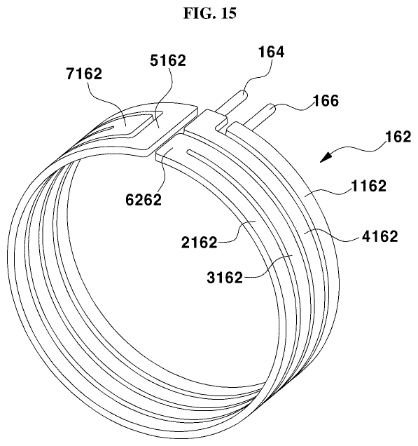

Referring to FIG. 14, according to an embodiment of the present disclosure, the in-wheel motor system 1 may include the cooling housing 160. The cooling housing 160 is disposed radially inside the stator 30. Additionally, the cooling housing 160 is disposed adjacent to the inner cover 40. In addition to cooling the stator 30, the cooling housing 160 may cool heat generated in the inner cover 40 by operation of the brake 80. In some embodiments, the cooling housing 160 may be integrated with the stator core 32. Alternatively, the cooling housing 160 and the stator core 32 may be separately formed and disposed to contact each other. Hereinafter, a description is given as to an example in which the cooling housing 160 is integrated with the stator core 32.

The cooling housing 160 includes a cooling channel 162. The cooling channel 162, which is a passage through which a coolant may flow, is formed in the stator core 32 or the cooling housing 160. In this example, the coolant flows through an inlet 164 and an outlet 166. The coolant flows through the inlet 164 where the coolant flows in and the outlet where the coolant after cooling is discharged.

In order to improve cooling performance, a coolant capacity or an area may be increased, or a specially designed water jacket structure having high cooling performance may be applied. In the former case, it is required to increase a thickness of the cooling channel. In this case, an increase in part size is required, which may lead to an insufficient space problem. Further, in this case, a space allocated to each part is reduced, which may cause deterioration in motor performance. In the latter case, cooling performance is improved, but it is difficult to manufacture the specially designed water jacket structure.

When the temperature of an internal winding is not uniform, output and durability of the in-wheel motor may be affected. Therefore, it is necessary to uniformly cool the inside of the in-wheel motor system 1. According to an embodiment of the present disclosure, the above-described problems may be solved by applying a U-turn flow route to the cooling channel 162, as described below.

Referring to FIG. 15, the cooling channel 162 is continuously formed as one channel. In other words, after the coolant introduced through the inlet 164 passes through the entire cooling channel 162, the coolant is discharged through the outlet 166 to form the U-turn flow route.

The cooling channel 162 has flow paths in various directions. The cooling channel 162 may extend in the circumferential direction of the stator core 32 and may extend in the axial direction of the stator core 32. The cooling channel 162 may change a direction thereof in the circumferential direction and the axial direction of the stator core 32 and may extend within the stator core 32, thereby providing a coolant flow path formed in various directions. The cooling channel 162 having the above-mentioned shape allows the coolant to flow or move in various directions at various locations within the stator core 32. To this end, the cooling channel 162 may include a plurality of channel portions 1162, 2162, 3162, 4162, 5162, 6162, and 7162.

According to an embodiment of the present disclosure, the cooling channel 162 may include the outer channel portions 1162 and 2162 and the inner channel portions 3162 and 4162. The outer channel portions 1162 and 2162 and the inner channel portions 3162 and 4162 are continuously connected to each other.

The outer channel portions 1162 and 2162 include the first outer channel portion 1162 extending in the circumferential direction of the stator core 32 from a side at the circumferential side of the stator core 32, i.e., from a first side of the stator core 32. Additionally, the outer channel portions 1162 and 2162 include the second outer channel portion 2162 extending in the circumferential direction of the stator core 32 from a second side opposite the first side of the stator core 32. The outer channel portions 1162 and 2162 may be disposed close to the outer periphery of the stator core 32.

The first outer channel portion 1162 and the second outer channel portion 2162 are connected to each other by the first connection portion 5162. The first outer channel portion 1162 and the second outer channel portion 2162 may extend in the circumferential direction of the stator core 32. The first connection portion 5162 may extend in the axial direction of the stator core 32. Accordingly, the first outer channel portion 1162 and the second outer channel portion 2162 may be spaced apart from each other by the first connection portion 5162. The flow direction of the coolant may be reversed in the channel portions 1162 and 2162.

The second outer channel portion 2162 is connected to the inner channel portions 3162 and 4162 by the second connection portion 6162. The inner channel portions 3162 and 4162 are disposed between the outer channel portions 1162 and 2162. In this manner, the first inner channel portion 3162 and the second inner channel portion 416 may be provided.

The first inner channel portion 3162 is connected to the second outer channel portion 2162 by the second connection portion 6162. The first inner channel portion 3162 extends in the circumferential direction of the stator core 32. The second connection portion 6162 extends in the axial direction of the stator core 32. Accordingly, the flow direction of the coolant in the cooling channel 162 may be changed through the second connection portion 6162. The first inner channel portion 3162 may allow the coolant to flow in a direction opposite the second outer channel portion 2162.

The first inner channel portion 3162 is connected to the second inner channel portion 4162. The third connection portion 7162 is provided between the first inner channel portion 3162 and the second inner channel portion 4162 to change the flow direction of the coolant. The third connection portion 7162 extends in the axial direction of the stator 30 from the second inner channel portion 4162. The second inner channel portion 4162 connected to the third connection portion 7162 extends in the circumferential direction of the stator core 32.

In other words, if the coolant flows in a first direction in the first outer channel portion 1162, the coolant flows in a second direction opposite the first direction in the second outer channel portion 2162. The coolant is configured to flow again in the first direction in the first inner channel portion 3162 and to flow again in the second direction in the second inner channel portion 4162. The flow direction of the coolant may be changed through the connection portions 5162, 6162, and 7162 each having a curved portion in the cooling channel 162.

In the drawing, a portion connected to the second inner channel portion 4162 is indicated as the inlet 164 into which the coolant is introduced, and a portion connected to the first outer channel portion 1162 is indicated as the outlet 166 through which the coolant is discharged. However, the present disclosure is not limited thereto. The first outer channel portion 1162 may be connected to the inlet 164 and the second inner channel portion 4162 may be connected to the outlet 166.

The cooling channel 162 may perform uniform cooling at a high heating temperature of a coil, such as 200 degrees Celsius or higher.

The in-wheel motor system 1 according to an embodiment of the present disclosure may enable high output while reducing the size of the in-wheel motor through the modular coil 100, the brake 80, and the cooling channel 162 described above.

As is apparent from the above description, the present disclosure provides an in-wheel motor system configured not only to reduce a size of an in-wheel motor but also to enable high output.

Additionally, the present disclosure provides an in-wheel motor system having improved efficiency.

The effects of the present disclosure are not limited to the above-mentioned effects. Other effects not mentioned herein should be more clearly understood by those having ordinary skill in the art from the detailed description of the embodiments.

The present disclosure described above is not limited to the above-described embodiments and the accompanying drawings. However, it should be appreciated by those having ordinary skill in the art that changes may be made in these embodiments without departing from the principles and spirit of the disclosure, the scope of which is defined in the appended claims and equivalents thereto.

What is claimed is:

1. An in-wheel motor system comprising:
a fixed part;
a rotating part configured to be rotatable relative to the fixed part; and
a brake mounted on the fixed part, the brake comprising a friction material disposed to contact the rotating part.

2. The in-wheel motor system of claim 1, wherein the rotating part comprises:
a rotor comprising a permanent magnet; and
an inner cover disposed inside the rotor and configured to contact the friction material.

3. The in-wheel motor system of claim 2, wherein the friction material is configured to contact an inner surface of the inner cover.

4. The in-wheel motor system of claim 2, wherein the brake further comprises a cylinder configured to move the friction material to enable the friction material to contact the inner cover.

5. The in-wheel motor system of claim 2, wherein the fixed part comprises a stator disposed inside the rotor, wherein a coil is wound around the stator.

6. The in-wheel motor system of claim 1, wherein the fixed part comprises a wheel bearing configured to rotatably support the rotating part and wherein the brake is mounted on the wheel bearing.

7. The in-wheel motor system of claim 1, further comprising a seal disposed between the fixed part and the rotating part and configured to seal a space between the fixed part and the rotating part.

8. The in-wheel motor system of claim 1, wherein the fixed part comprises a stator having a modular coil mounted thereon and wherein a current is applicable to the modular coil.

9. The in-wheel motor system of claim 8, wherein the modular coil comprises:
a coil main body having a flat plate coil formed in a preset shape; and
a coating layer configured to surround the coil main body.

10. The in-wheel motor system of claim 8, wherein the stator comprises teeth spaced apart from each other along a circumference of the stator and wherein the modular coil is mounted on each of the teeth.

11. The in-wheel motor system of claim 8, further comprising an insulating paper disposed between the modular coil and the stator.

12. The in-wheel motor system of claim 8, wherein the stator comprises a cooling housing comprising a cooling channel configured to allow a coolant to flow through the stator.

13. The in-wheel motor system of claim 12, wherein:
the cooling channel comprises an inlet and an outlet, wherein the inlet allows the coolant to flow thereinto, and the outlet allows the coolant to be discharged therethrough; and
the cooling channel is continuous from the inlet to the outlet.

14. The in-wheel motor system of claim 13, wherein the cooling channel is a single channel from the inlet to the outlet.

15. The in-wheel motor system of claim 12, wherein the cooling channel extends in a circumferential direction of the stator and an axial direction of the stator.

16. The in-wheel motor system of claim 12, wherein the cooling housing is integrally formed with the stator.

17. The in-wheel motor system of claim 12, wherein the cooling housing is disposed between the modular coil and the brake.

18. A vehicle driven by the in-wheel motor system of claim 1.
